(19) United States
(12) Patent Application Publication
(10) Pub. No.: US 2026/0198452 A1
(43) Pub. Date: Jul. 16, 2026

(54) FEEDER

(71) Applicant: Shenzhen Libro Technology Co., Ltd., Longgang District (CN)

(72) Inventors: Song HU, Longgang District (CN); Jiangnan CHENG, Longgang District (CN); Zhixiong LIANG, Longgang District (CN); Tianyu XIAO, Longgang District (CN)

(21) Appl. No.: 19/562,678

(22) Filed: Mar. 10, 2026

Related U.S. Application Data
(63) Continuation-in-part of application No. PCT/CN2024/110765, filed on Aug. 8, 2024.

(30) Foreign Application Priority Data
Sep. 11, 2023 (CN) 2023111746880
Sep. 11, 2023 (CN) 2023224773218
Sep. 11, 2023 (CN) 2023224779712

(51) Int. Cl. A01K 5/02

(52) U.S. Cl. CPC A01K 5/025; A01K 5/0291

(57) ABSTRACT

Disclosed is a feeder. The feeder includes: a housing, a metal inner container, a semiconductor refrigeration sheet, a food bowl, and a first heat insulation member.

### CROSS-REFERENCE TO RELATED APPLICATIONS

This application is filed as a bypass continuation-in-part application of PCT application PCT/CN2024/110765 filed Aug. 8, 2024, designating the United States, which claims priority to Chinese patent applications No. 202311174688.0, No. 202322477321.8, and No. 202322477971.2 which are all filed Sep. 11, 2023, the entire contents of which are incorporated herein by reference.

### TECHNICAL FIELD

The present disclosure relates to the technical field of feeding devices, and in particular, to a feeder.

### BACKGROUND

Compared to dry food, wet food has a stronger meaty aroma and a more moist texture, which is more likely to stimulate a pet's appetite. However, wet food is more susceptible to contamination by bacteria and mold than dry food. If wet food is not stored properly, it may cause food poisoning or other health problems of the pet. To ensure the freshness and safety of wet food, users generally use the wet food immediately after opening to avoid long-term exposure of the wet food to the air. Temperature control is also a method for preserving the wet food. However, the existing temperature-controlled feeder has a low refrigeration efficiency, posing a challenge to the preservation of the wet food.

### SUMMARY

To overcome the shortcomings of the existing technologies and provide a feeder with a good cold storage effect.

The present disclosure proposes a feeder including:
a housing including a first partition plate, wherein the first partition plate divides an interior of the housing into a first chamber and a second chamber that are spaced apart in an vertical direction, and the first partition plate is formed with a first through hole;
a metal inner container including a body part and a first boss part that are connected to each other, wherein the body part is arranged in the first chamber;
a semiconductor refrigeration sheet having a refrigeration end and a cooling end that are arranged relative to each other, wherein the first boss part passes through the first through hole and is connected to the refrigeration end;
a food bowl arranged in the first chamber, wherein the metal inner container exchanges heat with the refrigeration end and transfers the heat generated by means of heat exchange to the food bowl; and
a first heat insulation member at least arranged between the first partition plate and a plane at which the semiconductor refrigeration sheet is located, wherein the first heat insulation member is arranged around the first boss part.

In some embodiments of the present disclosure, the refrigeration end of the semiconductor refrigeration sheet exchanges heat with the first chamber through the metal inner container, which can reduce the temperature of the first chamber and thus keep the food in the food bowl fresh. The first heat insulation member is arranged between the first partition plate and the plane at which the semiconductor refrigeration sheet is located, which can effectively block the heat transfer process between the first chamber and the cooling end, thereby promoting the refrigeration end of the semiconductor refrigeration sheet to maintain a better refrigeration effect and thus ensuring a cold storage effect for the feeder.

### BRIEF DESCRIPTION OF DRAWINGS

To better clarify the embodiment of the present disclosure or the technical solution in the prior art, the accompanying drawings are provided to illustrate the embodiments or the prior art will be simply described below. It is apparent that the accompanying drawings described below merely illustrate some embodiments of the present disclosure. Those ordinary skilled in the art can obtain other drawings according to the structures shown in these accompanying drawings without creative labor.

FIG. 1 is an exploded schematic structural diagram of a feeder according to an embodiment of the present disclosure;

FIG. 2 is another exploded schematic structural diagram of a feeder according to an embodiment of the present disclosure;

FIG. 3 is further another exploded schematic structural diagram of a feeder according to an embodiment of the present disclosure;

FIG. 4 is a schematic structural diagram of a feeder according to an embodiment of the present disclosure;

FIG. 5 is a cross-sectional schematic structural diagram of a feeder according to an embodiment of the present disclosure;

FIG. 6 is another cross-sectional schematic structural diagram of a feeder according to an embodiment of the present disclosure;

FIG. 7 is still another exploded schematic structural diagram of a feeder according to an embodiment of the present disclosure;

FIG. 8 is further another cross-sectional schematic structural diagram of a feeder according to an embodiment of the present disclosure;

FIG. 9 is still another cross-sectional schematic structural diagram of a feeder according to an embodiment of the present disclosure;

FIG. 10 is a schematic structural diagram of a second partition plate and a metal inner container of a feeder according to an embodiment of the present disclosure;

FIG. 11 is an exploded schematic structural diagram of an upper cover of a feeder according to an embodiment of the present disclosure;

FIG. 12 is an exploded schematic structural diagram of a second drive mechanism of a feeder according to an embodiment of the present disclosure;

FIG. 13 is a cross-sectional schematic structural diagram of a locking member in a locking position of a feeder according to an embodiment of the present disclosure;

FIG. 14 is a cross-sectional schematic structural diagram of a locking member in an unlocking position of a feeder according to an embodiment of the present disclosure;

FIG. 15 is an enlarged schematic structural diagram of part A in FIG. 11;

FIG. 16 is a schematic structural diagram of a door body in a closing state of a feeder according to an embodiment of the present disclosure;

FIG. 17 is a schematic structural diagram of a door body in an opening or closing process of a feeder according to an embodiment of the present disclosure;

FIG. 18 is a schematic structural diagram of a door body in an opening state of a feeder according to an embodiment of the present disclosure;

FIG. 19 is a schematic structural diagram of a door body of a feeder according to an embodiment of the present disclosure;

FIG. 20 is an exploded schematic structural diagram of a damper of a feeder according to an embodiment of the present disclosure;

FIG. 21 is an exploded view of key components of another embodiment of the feeder of the present disclosure; and

FIG. 22 is a sectional view taken at line C-C of another embodiment of the feeder of the present disclosure.

List of reference numerals:

| Reference | | Reference | |
|---|---|---|---|
| numeral | Name | numeral | Name |
| 100 | housing | 650 | fourth groove |
| 110 | first partition plate | 651 | first limiting part |
| 111 | first through hole | 652 | second limiting part |
| 112 | surrounding plate | 660 | first sealing member |
| 113 | second through hole | 661 | second sealing member |
| 114 | fourth through hole | 670 | upper housing |
| 115 | feeding zone | 680 | lower housing |
| 116 | refrigeration zone | 681 | connecting hole |
| 120 | outer cylinder | 682 | fifth groove |
| 121 | air inlet frame | 690 | heat insulation layer |
| 122 | air outlet frame | 700 | cooling assembly |
| 130 | inner cylinder | 710 | cooling air duct |
| 140 | top plate | 711 | air inlet duct |
| 150 | bottom plate | 7111 | air inlet |
| 160 | second partition plate | 712 | air outlet duct |
| 161 | third through hole | 7121 | air outlet |
| 162 | first groove | 713 | first inclined part |
| 163 | second groove | 714 | second inclined part |
| 164 | third groove | 720 | fan |
| 200 | metal inner container | 730 | cooler |
| 210 | body part | 731 | cooling fin |
| 220 | first boss part | 7311 | inner fin |
| 300 | semiconductor | 7312 | outer fin |
| | refrigeration sheet | | |
| 310 | refrigeration end | 732 | heat-conducting |
| | | | substrate |
| 320 | cooling end | 7321 | second boss part |
| 400 | food bowl | 800 | first drive mechanism |
| 410 | food trough | 810 | first motor |
| 420 | avoidance slot | 820 | first transmission |
| | | | member |
| 500 | first heat | 900 | second drive mechanism |
| | insulation member | | |
| 510 | second heat | 910 | positioning part |
| | insulation member | | |
| 600 | upper cover | 920 | locking member |
| 610 | feeding port | 921 | hook part |
| 620 | door body | 922 | fixing part |
| 621 | clamping part | 930 | reset member |
| 622 | door handle | 940 | second transmission |
| | | | member |
| 623 | fifth through hole | 941 | cylinder part |
| 630 | light-transparent part | 942 | sensing part |
| 631 | light emitting device | 943 | sensing switch |
| 632 | light receiving device | 944 | notch |
| 640 | damper | 950 | second motor |
| 641 | damping sleeve | 960 | pressing plate |
| 642 | rotating member | 970 | bushing |
| 101 | heat conducting | 102 | first avoidance cavity |
| | member | | |
| 103 | second avoidance | 104 | heating member |
| | cavity | | |
| 40 | bracket | 402 | food container |

The realization process of the purpose, functional characteristics, and advantages of the present disclosure will be further described in combination with the embodiments and with reference to the accompanying drawings.

### DETAILED DESCRIPTION

The following clearly and completely describes the technical solutions in the embodiments of the present disclosure with reference to the accompanying drawings in the embodiments of the present disclosure. Apparently, the described embodiments are some rather than all of the embodiments of the present disclosure. Based on the embodiments of the present disclosure, all the other embodiments obtained by those ordinary skilled in the art, on the premise of not contributing creative effort, should belong to the claimed scope of the present disclosure.

It should be noted that all directional indications (such as: upper, lower, left, right, front, rear, etc.) in the embodiments of the present disclosure are merely used to explain the relative position relation, movement and the like of various components under a certain special posture (as shown in the accompanying drawings); and if this special posture is changed, the directional indications will change accordingly.

In the present disclosure, unless specific regulation and limitation otherwise, terms “connect”, “fix” and the like should be generally understood, for example, “fix” may denote a fixed connection, a detachable connection, or be integrated, may denote a mechanical connection or an electric connection, may denote a direct connection or an indirect connection through an intermediation, and may denote an internal connection of two elements or an interactive relationship of two elements, unless clearly specified otherwise. Those ordinary skilled in the art may understand the specific meaning of the terms in the disclosure according to specific conditions.

In addition, if the descriptions “first” and “second” are involved in the embodiments of the present disclosure, the descriptions “first” and “second” are merely used for description, instead of being understood as indicating or implying relative importance or impliedly indicating the quantity of the showed technical features. Thus, the features defined with “first” and “second” may expressly or impliedly one or more features. In addition, the meaning of “and/or” in the text includes three parallel schemes, take “A and/or B” for example, including A scheme, or B scheme, or the scheme meeting A and B at the same time. Thus, the technical solutions of various embodiments may be mutually combined, but it should be on the basis that such combinations may be achieved by those ordinary skilled in the art. When a combination of the technical solution has mutual contradiction or cannot be achieved, it should be considered as that such combination of the technical solution does not exist and does not fall in the claimed scope of the present disclosure.

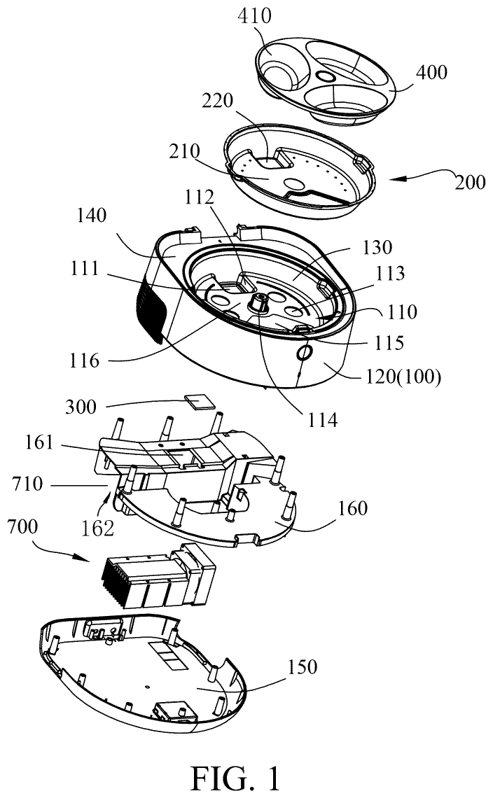

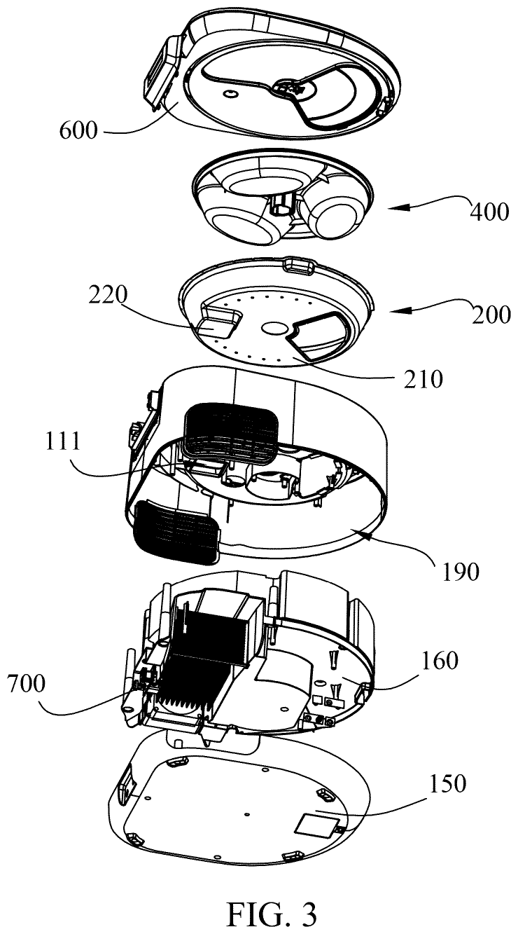

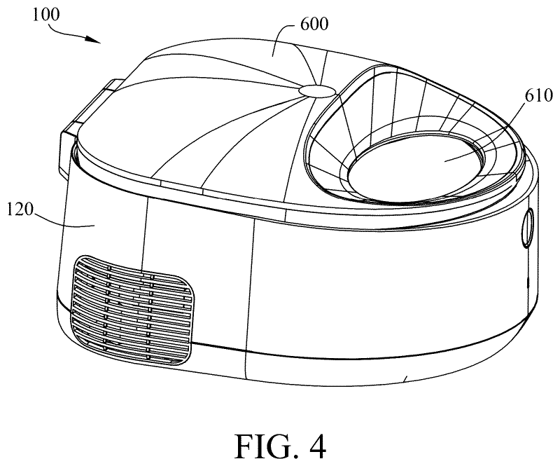

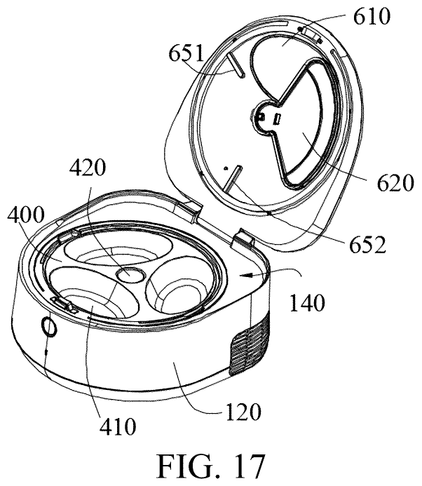

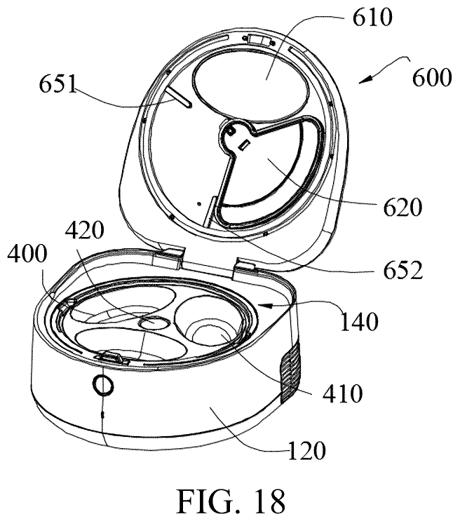

FIGS. 1 to 20 show specific embodiments of the feeder proposed in the present disclosure.

In an embodiment of the present disclosure, as shown in FIGS. 1-6, the feeder includes a housing 100, a metal inner container 200, a semiconductor refrigeration sheet 300, a food bowl 400, and a first heat insulation member 500. The housing 100 includes a first partition plate 110. The first partition plate 110 divides an interior of the housing 100 into a first chamber and a second chamber that are spaced apart in an vertical direction, and the first partition plate 110 is formed with a first through hole 111. The metal inner container 200 includes a body part 210 and a first boss part 220 that are connected to each other, and the body part 210 is arranged in the first chamber. The semiconductor refrigeration sheet 300 has a refrigeration end 310 and a cooling end 320 that are arranged relative to each other, and the first boss part 220 passes through the first through hole 111 and is connected to the refrigeration end 310. The food bowl 400 is arranged in the first chamber, and the metal inner container 200 exchanges heat with the refrigeration end 310 such that the semiconductor refrigeration sheet 300 refrigerates the food bowl 400. The first heat insulation member 500 is at least arranged between the first partition plate 110 and a plane at which plane the semiconductor refrigeration sheet 300 is located, and the first heat insulation member 500 is arranged around the first boss part 220.

In this embodiment, the refrigeration end 310 of the semiconductor refrigeration sheet 300 exchanges heat with the first chamber through the metal inner container 200, which can reduce the temperature of the first chamber and thus keep the food in the food bowl 400 fresh. The first heat insulation member 500 is arranged between the first partition plate 110 and the plane where the semiconductor refrigeration sheet 300 is located, which can effectively block the heat transfer process between the first chamber and the cooling end 320, thereby enabling the refrigeration end 310 of the semiconductor refrigeration sheet 300 to maintain a better refrigeration effect, and thus ensuring a good cold storage effect of the feeder.

It should be appreciated that connections include direct connections as well as indirect connections through an intermediation. In this embodiment, the first boss part 220 passes through the first through hole 111 and is directly connected to the refrigeration end 310. In other embodiments, the first boss part 220 passes through the first through hole 111 and is connected to a metal heat transfer block serving as an exemplary heat conducting member. The metal heat transfer block is connected to the refrigeration end 310. The metal heat transfer block 101 may be an aluminum block, a copper block, etc. For example, the metal heat transfer block 101 may pass through the first through hole 111 and be connected to the metal inner container and the refrigeration end 310, respectively.

The present disclosure is completed on the basis of the following applicant's findings: In the existing technologies, the design of the feeder that uses the Peltier device for food preservation is unreasonable. The temperatures of the refrigeration end 310 and the cooling end 320 will interfere with each other, which has a negative impact on the refrigeration capacity of wet food feeders.

In the technical solutions of the embodiments of the present disclosure, the shortcomings of the existing technologies are overcome. Specifically, the housing 100 surrounds to form a chamber. A first partition plate 110 is arranged in the chamber. The first partition plate 110 divides the chamber into a first chamber and a second chamber. The first chamber is located above the second chamber and is independent of the second chamber. The first chamber communicates with the second chamber through a first through hole 111 provided in the first partition plate 110. The semiconductor refrigeration sheet 300 is arranged relative to the first through hole 111. The metal inner container 200 is located in the first chamber, and the first boss part 220 of the metal inner container 200 extends toward the second chamber, passes through the first through hole 111, is connected to the refrigeration end 310, and exchanges heat with the refrigeration end 310, such that the refrigeration end 310 refrigerates the body part 210. The body part 210 transfers the low temperature energy to the food bowl 400 through the first chamber, thereby achieving the effect of keeping the food in the food bowl 400 fresh.

The first heat insulation member 500 is arranged between the first partition plate 110 and the area where the semiconductor refrigeration sheet 300 is located, which can effectively block the heat transfer process between the first chamber and the cooling end 320, thereby enabling the refrigeration end 310 of the semiconductor refrigeration sheet 300 to maintain a better refrigeration effect, and thus ensuring a good cold storage effect of the feeder.

It should be appreciated that the areas between planes, which planes are located between the refrigeration end 310 and the cooling end 320 along the vertical direction, may be defined as a first area. In this embodiment, at least part of the first heat insulation member 500 is arranged between the first partition plate 110 and the first area, that is, at least part of the first heat insulation member 500 extends downward from the bottom of the first partition plate 110 to the location between the refrigeration end 310 and the cooling end 320 of the semiconductor refrigeration sheet 300. In other embodiments, at least part of the first heat insulation member 500 is arranged between the first partition plate 110 and the plane where the refrigeration end 310 is located, that is, at least part of the first heat insulation member 500 extends downward from the bottom of the first partition plate 110 to a position slightly higher than the refrigeration end 310 of the semiconductor refrigeration sheet 300; or at least part of the first heat insulation member 500 is arranged between the first partition plate 110 and the plane where the cooling end 320 is located, that is, at least part of the first heat insulation member 500 extends downward from the bottom of the first partition plate 110 to a position slightly lower than the heat dissipation end 320 of the semiconductor refrigeration sheet 300. In short, when it is described that the first heat insulation member 500 is arranged between the first partition plate 110 and the plane where the semiconductor refrigeration sheet 300 is located, it may be understood that at least part of the first heat insulation member 500 may extend downward to a position slightly higher than the refrigeration end 310 of the semiconductor refrigeration sheet 300, a first area of the refrigeration end 310 and the cooling end 320 in the vertical direction, or a position slightly lower than the cooling end 320 of the semiconductor refrigeration sheet 300.

As shown in FIG. 1, the metal inner container 200 is made of aluminum, which has good heat conduction efficiency. The body part 210 and the first boss part 220 of the metal inner container 200 are integrally formed. The body part 210 is as thick as the first boss part 220 to ensure a good heat transfer effect. The body part 210 extends to most of the area of the bottom wall of the first chamber. The part that the food bowl 400 is opposite to the metal inner container 200 receives the low temperature energy transferred by the metal inner container 200, thereby keeping the food fresh. In the specific implementation process, the metal inner container 200 may be directly formed with the first boss 220 through a mold, or by stamping.

As shown in FIG. 1, the feeder includes a surrounding plate 112 extending downward from an inner peripheral wall of the first through hole 111. An outer peripheral wall of the surrounding plate 112 is connected to the first heat insulation member 500, and an inner peripheral wall of the surrounding plate 112 is connected to the first boss part 220.

In this embodiment, the surrounding plate 112 is connected to one side of the first partition plate 110 deviating from the first chamber and is arranged around the first through hole 111 in a circumferential direction, and the surrounding plate 112 extends from the first through hole 111 to a direction away from the first partition plate 110. In the specific implementation process, the surrounding plate 112 and the first partition plate 110 are integrally formed. An inner peripheral wall of the surrounding plate 112 is in contact with the first boss part 220, and an outer peripheral wall of the surrounding plate 112 is connected to the heat insulation member to prevent the temperature energy of the first boss part 220 from spreading from the surrounding plate 112 to the surrounding area, thus ensuring a good refrigeration effect of the first boss part 220.

In this embodiment, a bottom wall of the first boss part 220 is connected to the refrigeration end 310, and a side wall of the first boss part 220 is connected to the surrounding plate 112. Specifically, the metal inner container 200 is arranged between the food bowl 400 and the first partition plate 110. The metal inner container 200 is recessed from one side facing the food bowl 400 to the second chamber, that is, the first boss part 220 is formed on one side of the metal inner container 200 facing the first partition plate 110. The bottom of the first boss part 220 passes through the first through hole 111 and is bonded to the refrigeration end 310, and the first boss part 220 is bonded to the refrigeration end 310 through thermally conductive adhesive, which thermally conductive adhesive may serve as another example of the heat conducting member 101. In this way, as the thickness of the thermally conductive adhesive is very thin, the refrigeration end 310 is in almost direct contact and exchange heat with the metal inner container 200, reducing temperature loss caused by connecting through an adapter and improving the refrigeration efficiency and refrigeration effect. The first boss part 220 passes through the first through hole 111 such that the first boss part 220 extends out of the first partition plate 110. The side wall of the first boss part 220 is connected to the surrounding plate 112 to support the first boss part 220 and avoid the temperature loss from the first boss part 220.

In addition, since the metal inner container 200 is recessed in the direction of the second chamber, the condensed water, which is formed on the surface due to the fact that the metal inner container 200 is refrigerated, may also be contained through such a recess.

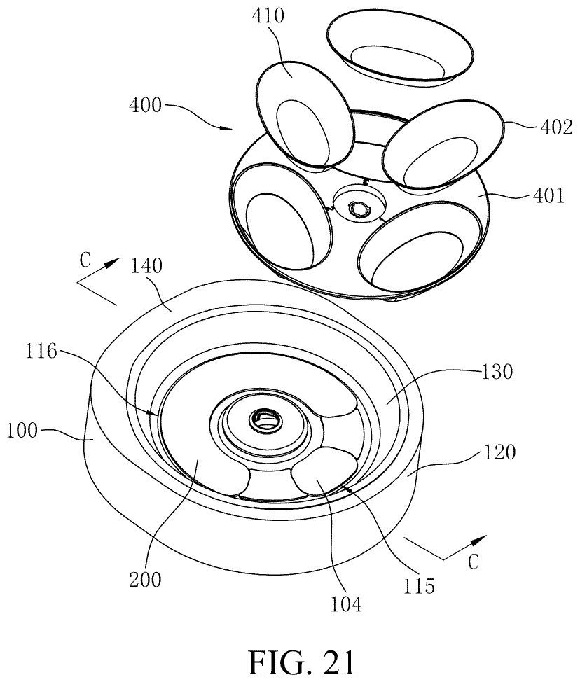

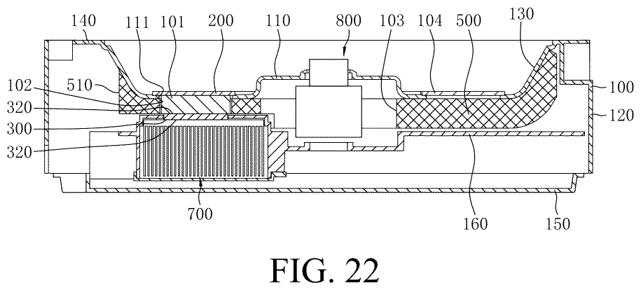

Although an example, in which the metal inner container 200 having the first boss part 220, has been described above, it is not limited to this. The metal inner container 200 may not have the first boss part 220. In the followings, an example, in which the metal inner container 200 does not have the first boss part 220, will be described mainly with reference to FIGS. 21 and 22. It should be noted that in FIGS. 21 and 22, for the convenience of illustration, the same or similar technical features as those in other embodiments are given the same reference numerals. In addition, the schematic diagrams are simplified.

In this example, as those examples described above, the semiconductor refrigeration sheet 300 is, for example, rectangular, and correspondingly, the first through hole 111 is rectangular. The semiconductor refrigeration sheet 300 is located below the first partition plate 110 in the vertical direction in a manner that is substantially symmetrical with the center of the first through hole 111, and a gap is formed between the semiconductor refrigeration sheet 300 and the first partition plate 110 in the vertical direction. The length and width of the first through hole 111 are slightly larger than those of the semiconductor refrigeration sheet 300, respectively, so that the refrigeration end 310 of the semiconductor refrigeration sheet 300 is completely exposed from the first through holes 111 when observed from the perspective of looking down from the top of the first chamber. In addition, the feeder may not include the surrounding plate 112.

In addition, unlike that has been described in the above embodiment, the metal inner container 200 is an arc-shaped and plate-shaped member. The entire metal inner container 200 is laid on the first partition plate 110 in a manner of covering the first through hole 111. Between the metal inner container 200 and the refrigeration end 310 of the semiconductor refrigeration sheet 300, various heat conducting members 101 including the above-mentioned metal heat transfer blocks may be arranged, and the heat conducting members 101 can pass through the first through holes 111 to connect to the metal inner container 200 and the refrigeration end 310 respectively.

Part of the first heat insulation member 500 is located at the lower part of the first partition plate 110, and the circumferential direction of the semiconductor refrigeration sheet 300 is surrounded by the first heat insulation member 500 when observed from the perspective of looking down from the top of first heat insulation member 500. Specifically, the first heat insulation member 500 has a plate-like portion, which portion as a whole is in the shape of a disk and located below the first partition plate 110 entirely. The first heat insulation member 500 has a rectangular first avoidance cavity 102 at a position corresponding to the first through hole 111, and the length and width of the first avoidance cavity 102 are approximately the same as those of the first through hole 111. The heat conducting member 101 is accommodated in the first avoidance cavity 102, which can also be understood as that: the part of the first heat insulation member 500, which part is located at the lower part of the first partition plate 110, at least surrounds the heat conducting member 101 from the circumferential direction of the heat conducting member 101.

In addition, the first avoidance cavity 102 can only surround the heat conducting member 101 from the circumferential direction. In this case, the lower part of the first heat insulation member 500 can be approximately flush with or slightly higher than the surface of the refrigeration end 310 of the semiconductor refrigeration sheet 300. Alternatively, the first avoidance cavity 102 can also surround part of the semiconductor refrigeration sheet 300, in which case the lower part of the first heat insulation member 500 extends to the area (that is, the first area) between the refrigeration end 310 and the cooling end 320 in the vertical direction. Alternatively, the first avoidance cavity 102 can completely surround the whole of the heat conducting member 101 and the semiconductor refrigeration sheet 300. In this case, the lower part of the first heat insulation member 500 extends to a position approximately flush with or slightly lower than the surface of the semiconductor refrigeration sheet 300. In any case, the circumferential direction of the semiconductor refrigeration sheet 300 is surrounded by the first heat insulation member 500 when observed from the perspective of viewing from top to bottom. In this way, the part of the first heat insulation member 500 located at the lower part of the first partition plate 110 effectively insulates the surrounding area of the heat conducting member 101 while avoiding the heat conducting member 101 or avoiding both the heat transfer member 101 and the semiconductor refrigeration sheet 300.

As shown in FIG. 1, the first partition plate 110 is provided with a second through hole 113, the metal inner container 200 covers the second through hole 113, and the first partition plate 110 is bonded to the metal inner container 200. In the specific implementation process, the metal inner container 200 is connected to the first partition plate 110. The first partition plate 110 is made of plastic, and the metal inner container 200 is fixedly connected to the first partition plate 110 through the overmolding process. During the overmolding process, the metal inner container 200 is inverted in the mold, a part of the mold abuts against the metal inner container 200, and then the injection material is poured into the mold. After the process is completed, the part of the metal inner container 200 that is abutted by the mold is not covered by the injection material, and the aforementioned third through hole 161 is formed thereon. After the first partition plate 110 is connected to the metal inner container 200 through the overmolding process, the metal inner container 200 is tightly connected with the first partition plate 110, which can effectively prevent the condensate formed in the first chamber from entering the second chamber through a space between the metal inner container 200 and the first partition plate 110, thus achieving a good sealing effect.

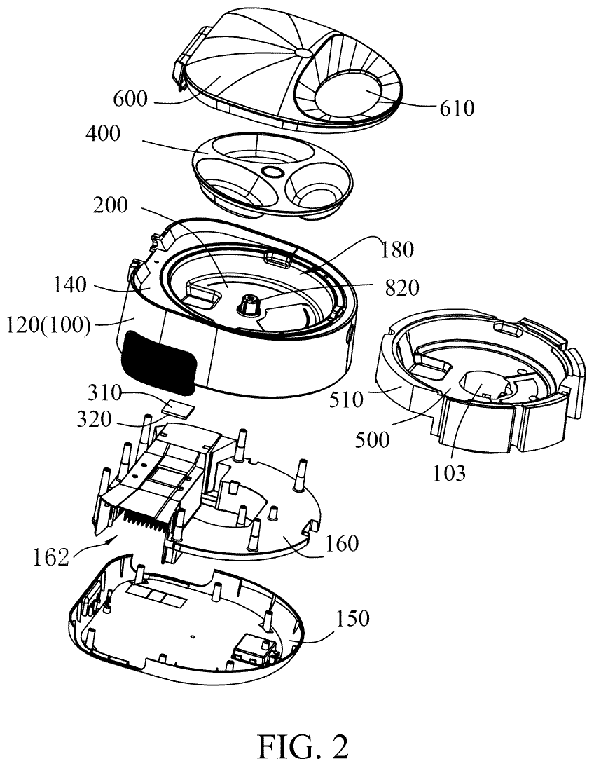

As shown in FIGS. 2 and 22, the housing 100 further includes an outer cylinder 120, an inner cylinder 130, a top plate 140, and a bottom plate 150. The first partition plate 110 is connected to an inner peripheral wall of the inner cylinder 130, such that the first partition plate 110 and the inner cylinder 130 surround to form the first chamber. The top plate 140 is connected between a top end of the outer cylinder 120 and a top end of the inner cylinder 130, such that the top plate 140, the inner cylinder 130, and the outer cylinder 120 surround to form an annular cavity. The bottom plate 150 is connected to a bottom end of the outer cylinder 120, such that the outer cylinder 120, the first partition plate 110, and the bottom plate 150 surround to form the second chamber. The annular cavity is provided with a second heat insulation member 510.

In this embodiment, the inner cylinder 130 is located within the space enclosed by the outer cylinder 120, the first partition plate 110 is located within the space enclosed by the inner cylinder 130, and the first partition plate 110 is also connected to the inner peripheral wall of the inner cylinder 130. The first chamber is located within the space enclosed by the first partition plate 110 and the inner cylinder 130. Edges of one side of the top plate 140 are connected to the inner cylinder 130, and edges of the other side of the top plate 140 are connected to the outer cylinder 120; and the top plate 140, the inner cylinder 130, and the outer cylinder 120 surround to form the annular cavity. The bottom plate 150 is connected to one end of the outer cylinder 120 deviating from the top plate 140, and the bottom plate 150, the outer cylinder 120, and the first partition plate 110 surround to form the second chamber. The first heat insulation member 500 is located in the second chamber, which prevents the heat in the second chamber from affecting the refrigeration effect of the first chamber. The second heat insulation member 510 is arranged in the annular cavity to keep the first chamber warm and further ensure a good refrigeration and preservation effect of the first chamber. In addition, the first heat insulation member 500 and the second heat insulation member 510 are integrally formed to save the needs for processes and procedures.

As shown in FIGS. 1 and 22, the feeder further includes a second partition plate 160. The second partition plate 160 is arranged between the first partition plate 110 and the bottom plate 150, the second partition plate 160 is connected to an inner peripheral wall of the outer cylinder 120, the second partition plate 160 is provided with a third through hole 161, the third through hole 161 is provided correspondingly to the cooling end 320, and the first heat insulation member 500 is mounted on the second partition plate 160.

In this embodiment, the second partition plate 160 is connected to the bottom plate 150 and the first partition plate 110, respectively. For example, the first partition plate 110 and the second partition plate 160 may be connected by screws passing through the first heat insulation member 500. Of course, after passing through the bottom plate 150, the screws may be connected to the first partition plate 110 and the second partition plate 160, respectively, thereby achieving locking and fixing of the screws, the first partition plate 110, and the second partition plate 160. The first heat insulation member 500 is arranged in the space between the second partition plate 160 and the first partition plate 110, to avoid heat exchange between the second chamber and the first chamber, thereby ensuring the refrigeration effect of the first chamber. In the specific implementation process, the second partition plate 160 is provided with a third through hole 161, the cooling end 320 is arranged correspondingly to the third through hole 161 and communicates with the second chamber through the third through hole 161.

As shown in FIG. 1, the feeder further includes a cooling assembly 700. A first groove 162 is formed in one side of the second partition plate 160 facing the bottom plate 150, the first groove 162 and the bottom plate 150 form a cooling air duct 710 together, and the cooling assembly 700 is arranged in the cooling air duct 710 and is configured to cool the cooling end 320.

In this embodiment, the cooling end 320 is connected to the cooling assembly 700. The cooling assembly 700 cools the heat generated by the cooling end 320, preventing hot airflow from remaining in the second chamber for a long time and affecting the refrigeration effect. In the specific implementation process, the cooling assembly 700 includes a cooler and a fan. The cooler is connected to the cooling end 320 and exchanges heat with the cooling end 320 to achieve the cooling effect. The second partition plate 160 is recessed from one side facing the bottom plate 150, to form the first groove 162. The cooling air duct 710 is formed between the first groove 162 and the bottom plate 150. An air inlet and an air outlet are provided on two opposite sides of the housing 100. The fan causes the cooling air duct 710 to form a cooling airflow. External air enters the cooling air duct 710 from the air inlet 7111 and is discharged from the air outlet 7121. The cooling assembly 700 is located in the cooling air duct 710. The cooling airflow passes through the cooler 730 and carries away the heat on the surface of the cooler 730, thus achieving the cooling effect. After passing through the cooler 730, the low-temperature airflow entering through the air inlet 7111 carries the heat away from the cooler 730, causing the temperature of the low-temperature airflow to rise, thereby forming a high-temperature airflow. Since the air inlet 7111 and the air outlet 7121 are arranged oppositely to each other, the high-temperature airflow formed by the cooler 730 is directly discharged through the air outlet 7121 and will not stay in the second chamber for a long time, thus a good cooling effect is achieved.

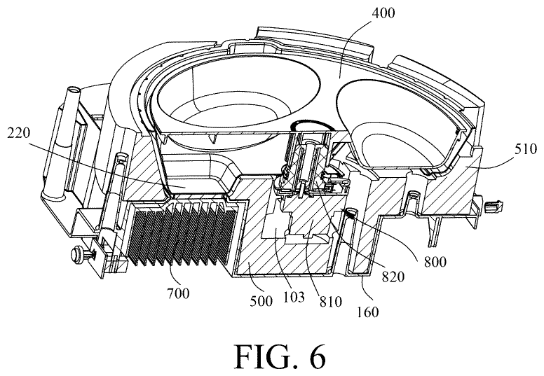

As shown in FIG. 6, the feeder further includes a first drive mechanism 800 for driving the food bowl 400 to rotate, and the first heat insulation member 500 has a second avoidance cavity 103 for avoiding the first drive mechanism 800.

As shown in FIG. 6, the first heat insulation member 500 is located between the second partition plate 160 and the first partition plate 110. One side of the first heat insulation member 500 facing the first partition plate 110 is recessed towards the second chamber, such that the second avoidance cavity 103 is formed in one side of the first heat insulation member 500 facing the first partition plate 110. Meanwhile, one side of the first heat insulation member 500 facing the second chamber protrudes towards the second chamber, and correspondingly, the second partition plate 160 is recessed correspondingly to form an accommodating slot to accommodate the protruding part of the first heat insulation member 500. The first drive mechanism 800 drives the food bowl 400 to rotate in the first chamber. One end of the first drive mechanism 800 is located in the second avoidance cavity 103, and the other end extends out of the first partition plate 110 and is connected to the bottom bowl, to drive the food bowl 400 to rotate.

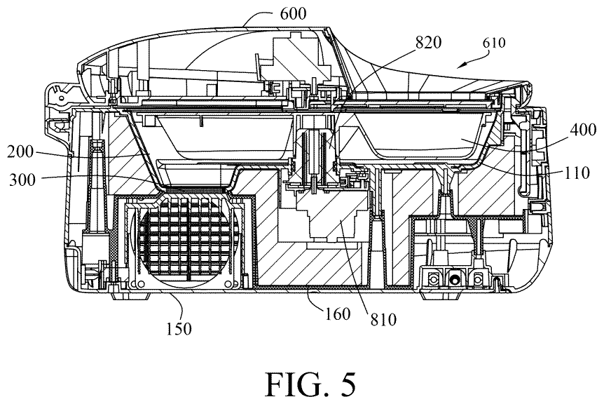

As shown in FIGS. 1 and 5, the first partition plate 110 has a fourth through hole 114. The first drive mechanism 800 includes a first motor 810 and a first transmission member 820 that are connected with each other. The first motor 810 is arranged in the second avoidance cavity 103, the first transmission member 820 passes through the fourth through hole 114 and enters the first chamber, and the first transmission member 820 is detachably connected to the food bowl 400. When the first transmission member 820 is connected to the food bowl 400, the first motor 810 drives the food bowl 400 to rotate.

An output shaft of the first motor 810 of the first drive mechanism 800 is connected to the first transmission member 820. One end of the first transmission member 820 passes through the fourth through hole 114 and is in drive connection with the food bowl 400, and both the first transmission member 820 and the food bowl 400 are detachable. Specifically, one of the first transmission member 820 and the food bowl 400 is provided with a raised part, and the other is provided with a recess. The raised part is in mutual cooperation and connection with the recess, to restrict the circumferential rotation of the first transmission member 820 and the food bowl 400. In this way, the first transmission member 820 rotates to drive the food bowl 400. For example, the food bowl 400 is connected to the first transmission member 820 by a spline, or the food bowl 400 is detachably plugged with the first transmission member 820, which is convenient for disassembling.

In this embodiment, the food bowl 400 is provided with a plurality of food troughs 410 distributed at intervals along the circumferential direction. By rotating the food bowl 400, the positions of the food troughs 410 in the first chamber may be switched, thereby achieving the effect of refrigerating and preserving the food in different food troughs 410. It should be appreciated that the central position of the food bowl 400 is connected to the first transmission member 820, thereby ensuring that the first motor 810 drives the food bowl 400 to rotate stably. The food bowl 400 can be integrally molded with a heat-conducting material such as a metal material, for example, a metal plate can be stamped to form a plurality of food troughs 410 distributed at intervals in the circumferential direction. In addition, the food bowl 400 can also be formed by the way of assembly. For example, the food bowl 400 can include a bracket 401 detachably mounted to the first transmission member 820 and a plurality of food containers 402 detachably mounted to the bracket 401 at intervals along the circumferential direction of the bracket 401. The bracket 401 is made of a heat insulating material such as plastic, and the bracket 401 may be provided with a recess, and correspondingly, the first transmission member 820 is provided with a raised part, so that the bracket 401 can be detachably mounted to the first transmission member 820. The plurality of food containers 402 are each made of a material with thermal conductivity such as metal, and each food trough 410 is formed in each food container 402. Thus, only the food containers 402 forming the food troughs 410 in the food bowl 400 can be refrigerated, and the refrigeration efficiency may be improved.

As shown in FIG. 1, the first partition plate 110 includes a refrigeration zone 116 and a feeding zone 115. The refrigeration zone 116 and the feeding zone 115 are arranged along the circumferential direction of the first chamber. For example, the refrigeration zone 116 occupies about ⅔ of the area of the first chamber in the circumferential direction, while the feeding zone 115 occupies about ⅓ of the area of the first chamber. An area of the refrigeration zone 116 is larger than that of the feeding zone 115. The metal inner container 200 is located in the refrigeration zone 116.

In this embodiment, the metal inner container 200 is tightly connected to the first partition plate 110. Correspondingly, the metal inner container 200 is connected to the part of first partition plate 110 corresponding to the refrigeration zone 116, while the part corresponding to the feeding zone 115 is not connected to the metal inner container 200. In practice, the food in the food bowl 400 corresponding to the pet feeding zone 115 is kept at a relatively high temperature and the food in the food bowl 400 corresponding to the refrigeration zone 116 is kept at a low temperature, thus keeping the food in the food bowl 400 fresh and avoiding food spoilage. In addition, when rotated to the feeding zone 115, the food in the corresponding food trough 410 of the food bowl 400 will be heated and thawed, making it easier for the pet to eat. In addition, in order to improve the heating efficiency of the food troughs 410 in the feeding zone 115, a heating member 104 may be arranged in area of the feeding zone 115 of the first partition plate 110, the heating member 104 and the metal inner container 200 may be separated from each other. The form of the heating member 104 is not particularly limited, for example, it may be plate-shaped and made of mica material, ceramic material, metal material, etc. In addition, it may also be a filament such as a nickel-chromium wire. The manner of separation is not particularly limited. For example, a heat insulating material may be provided between the heating member 104 and the metal inner container 200.

In addition, the first heat insulation member 500 includes a part located below the feeding zone 115 of the first partition plate 110, which part covers the heating member 104 from bottom to top, so that the diffusion of heat from the heating member 104 to the second chamber can be suppressed. Therefore, on the whole, it can also be understood that the first heat insulation member 500 has a plate-like part in the shape of a disk, which part is located below the first partition plate 110, and the first heat insulation member 500 is only provided with the first avoidance cavity 102 for avoiding the heat conducting member 101 and with the second avoidance cavity 103 for avoiding the first drive mechanism 800. Further, the first heat insulation member 500 is flat and attached to the first partition plate 110. In this way, the refrigeration zone 116 and the feeding zone 115 of the first chamber can be effectively heat-insulated.

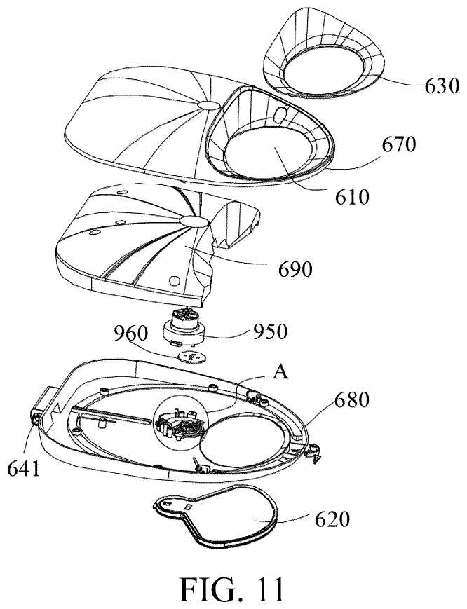

As shown in FIGS. 2 and 11, the housing 100 includes an upper cover 600 that covers the first chamber, and the upper cover 600 is provided with a feeding port 610 communicating with the first chamber. In the specific implementation process, the upper cover 600 is located above the first chamber and is configured to open and close the first chamber. When opened, the first chamber may be configured to place food or food container 402 into the food bowl 400. When the first chamber is closed, the pet can eat the food on the food bowl 400 through the feeding port 610 of the upper cover 600. The feeding port 610 is arranged to correspond to the feeding zone 115 of the first partition plate 110, which avoids the food temperature being too low and affecting the pet's eating. The pet eats and drinks the food of the food bowl 400 located in the food trough 410 of the feeding zone 115 through the feeding port 610. In addition, to ensure a good refrigeration and preservation effect of the first chamber, the upper cover 600 further includes a door body 620. After the pet stops eating, the door body 620 may be controlled to close the feeding port 610, to prevent the first chamber from exchanging heat with the outside which may cause the temperature to rise and lead to food spoilage. When the pet needs to eat, the door body 620 may be controlled to open the feeding port 610 to allow the pet to eat. It should be appreciated that the first drive mechanism 800 drives the food bowl 400 to rotate, and different food troughs may be switched to correspond to the feeding port 610, such that the pet may eat different foods.

### Cooling Assembly

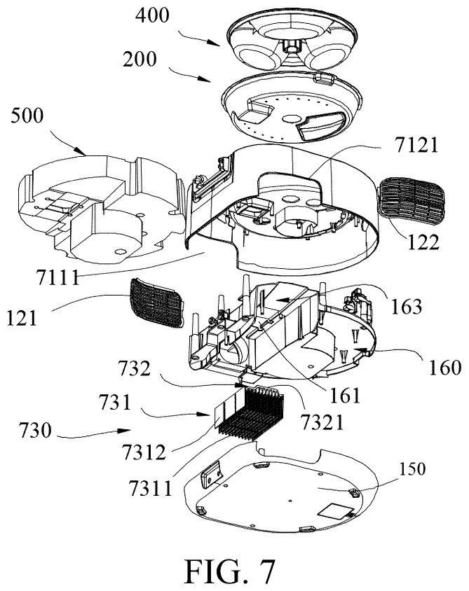

In this embodiment, as shown in FIGS. 7-10, the second partition plate 160 divides the second chamber into a third chamber and a fourth chamber that are spaced apart in an vertical direction. The second heat insulation member 510 is arranged in the third chamber. The second partition plate 160 is provided with a third through hole 161. The semiconductor refrigeration sheet 300 is arranged to correspond to the third through hole 161. The cooling end 320 faces the fourth chamber. The cooling assembly 700 is arranged in the fourth chamber. A cooling air duct 710 is formed in the fourth chamber. The air inlet 7111 and the air outlet 7121 of the cooling air duct 710 are arranged on two opposite side walls of the fourth chamber, respectively. The cooling assembly 700 is arranged in the cooling air duct 710 and is configured to cool the cooling end 320.

In this embodiment, the refrigeration end 310 of the semiconductor refrigeration sheet 300 exchanges heat with the first chamber, which can reduce the temperature of the first chamber and thus keep the food in the food bowl 400 fresh. The cooling end 320 faces the fourth chamber, which can reduce the amount of heat transferred to the first chamber. At the same time, the air inlet 7111 and air outlet 7121 of the cooling air duct 710 are arranged oppositely to each other, such that heat can be dissipated quickly and effectively, to avoid heat backflow. The present disclosure is completed on the basis of the following applicant's findings: In the existing technologies, the design of the feeder that uses the Peltier device for food preservation has the following design flaws: for example, in a solution where air enters the housing through a vent on the side of the housing, is drawn through a cooling sheet, and then discharged through an exhaust port at the bottom of the housing, thus the hot airflow cannot be discharged quickly because of the at least characteristic of hot air that it tends to rise. For example, in a solution where the preservation room and the cooling room are placed one after the other, due to structural limitations, the airflow needs to be discharged from the outlet after passing through the cooler. In this process, the hot airflow will be obstructed by corners and curves.

In the technical solutions of the embodiments of the present disclosure, the shortcomings of the existing technologies are overcome. Specifically, in this embodiment, the housing 100 has a second chamber. The second chamber is divided through the second partition plate 160 to form the third chamber and the fourth chamber. The third chamber is above the fourth chamber and the third chamber is interconnected to the fourth chamber by the third through hole 161 in the second partition plate 160. The food bowl 400 is located in the first chamber. The refrigeration end 310 of the semiconductor refrigeration sheet 300 faces the first chamber through the third through hole 161 and lowers the temperature in the first chamber, thus achieving a refrigeration effect and keeping the food in the food bowl 400 fresh. The cooling end 320 of the semiconductor refrigeration sheet 300 faces the fourth chamber, and the cooling assembly 700 is arranged in the fourth chamber to cool the semiconductor refrigeration sheet 300, thus playing a cooling role. Specifically, the fourth chamber is formed with the cooling air duct 710. The air inlet 7111 and the air outlet 7121 are arranged oppositely to each other and provided on the two opposite side walls of the fourth chamber. In this way, a cooling airflow is formed which flows from the air inlet 7111 to the air outlet 7121. The cooling assembly 700 is connected to the cooling end 320 and exchanges heat with the cooling end 320. The cooling airflow flows from the air inlet 7111 to the air outlet 7121 and passes through the cooling assembly 700, to carry away the heat of the cooling assembly 700, thereby cooling the cooling end 320.

The groove 162 is formed in one side of the second partition plate 160 facing the fourth chamber. The first groove 162 and the bottom wall of the fourth chamber form the cooling air duct 710 together. The structure provided in this embodiment is simple.

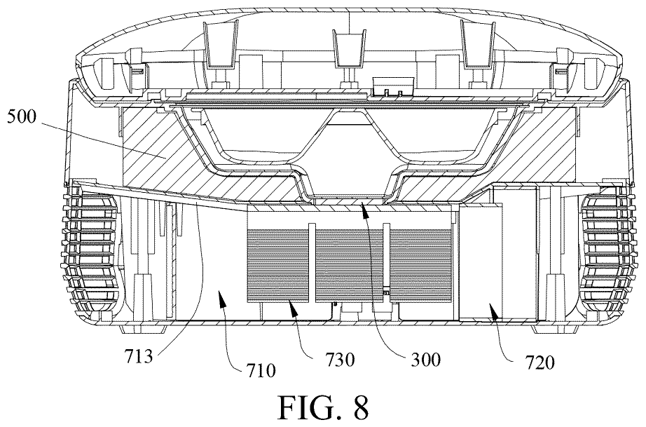

As shown in FIG. 8, the cooling assembly 700 includes a fan 720. The cooling air duct 710 has an air inlet duct 711 and an air outlet duct 712. The air inlet 7111 and an air inlet side of the fan 720 are in communication with the air inlet duct 711, the air outlet 7121 and an air outlet side of the fan 720 are in communication with the air outlet duct 712, and an overflowing area of at least a section of the air outlet duct 712 gradually increases along the direction of the air outlet 7121. The solution in this embodiment can effectively improve the efficiency that the cooling airflow is discharged from the air outlet 7121, thus accelerating the airflow discharging speed and improving the cooling efficiency.

In the specific implementation process, the air inlet duct 711 and the air outlet duct 712 form the cooling air duct 710. It should be appreciated that the part between the air inlet side of the fan 720 and the air inlet 7111 is the air inlet duct 711, and the part between the air outlet side of the fan 720 and the air outlet 7121 is the air outlet duct 712. Under the action of the fan 720, external airflow enters the air inlet duct 711 from the air inlet 7111, enters the air outlet duct 712 after passing through fan 720, and is finally discharged from air outlet 7121.

It should be appreciated that the contact part of the cooling assembly 700 and the cooling end 320 may be located in the air inlet duct 711 or in the air outlet duct 712. Of course, in order to ensure a good cooling effect, the cooling assembly 700 is preferably located in the air outlet duct 712.

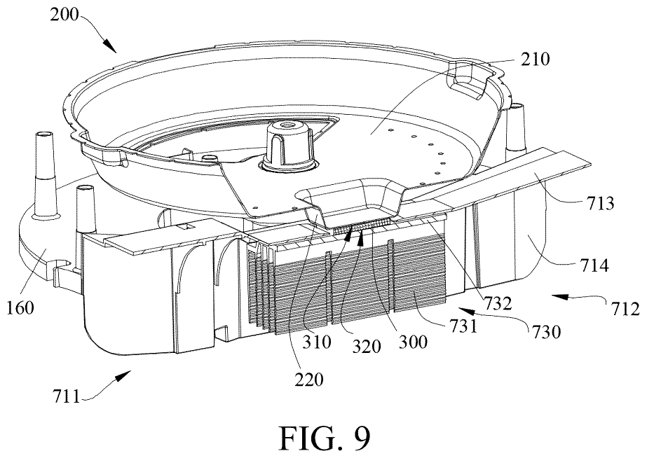

It should be appreciated that the specific implementations to achieve “the overflowing area of at least a section of the air outlet duct 712 gradually increases along the direction of the air outlet 7121” include at least the following implementations: Implementation 1: as shown in FIG. 9, the bottom wall of the first groove 162 has a first inclined part 713, which first inclined part 713 is inclined upward toward the bottom wall surface away from the fourth chamber. Implementation 2: as shown in FIG. 9, the side wall of the first groove 162 has a second inclined part 714, which second inclined part 714 is inclined outward toward the air outlet 7121.

In the specific implementation process, the air outlet duct 712 may only be provided with the first inclined part 713, or only with the second inclined part 714, or both.

As shown in FIG. 8, the overflowing area of at least a section of the air inlet duct 711 gradually increases along the direction of the air inlet 7111. In the solution of this embodiment, the cross-sectional area of the air duct section near the fan 720 is relatively small, which can increase the speed and pressure of the airflow here, providing sufficient thrust for the hot airflow to overcome the resistance of the entire air duct system and maintain good airflow circulation and fluidity.

In this embodiment, the cross-sectional area of the air outlet duct 712 increases in the section near the air outlet 7121, while the cross-sectional area of the air inlet duct 711 decreases in the section near the fan 720. Since the airflow can gradually converge from a large cross-sectional area to a small cross-sectional area in the air inlet duct 711, the airflow speed increases and the thrust is improved, forming a stronger convection effect inside the cooler 730. Since the air outlet 7121 is the final outlet for airflow, the air duct section with a larger cross-sectional area of the air outlet duct 712 allows more hot airflow to pass through and get contact with the air outlet 7121, thereby effectively dissipating heat from the housing 100.

As shown in FIG. 7, the cooling assembly 700 includes a cooler 730. The cooler 730 includes a heat-conducting substrate 732 and a plurality of cooling fins 731. The heat-conducting substrate 732 is connected to the cooling end 320, the plurality of cooling fins 731 are distributed on the heat-conducting substrate 732 at intervals, a cooling channel is formed between two adjacent cooling fins 731, and an extending direction of the cooling channel is the same as that of the cooling air duct 710.

In the specific implementation process, both the heat-conducting substrate 732 and the cooling fins 731 are made of metal with good thermal conductivity and may be integrally formed. One side of the heat-conducting substrate 732 is connected to the cooling end 320 by means of bonding or bolts. The heat-conducting substrate 732 exchanges heat with the cooling end 320 of the semiconductor refrigeration sheet 300. The other side of the heat-conducting substrate 732 is provided with multiple spaced cooling fins 731, and the heat is further transferred to the cooling sheet. The cooling fins 731 are arranged on the heat-conducting substrate 732 at intervals, and a cooling channel is formed between adjacent cooling fins 731. After passing through the cooling channel, the cooling airflow carries away the heat on the surfaces of the cooling fins 731, thereby achieving the cooling effect. The extension direction of the cooling channel is the same as that of the cooling air duct 710, that is, the cooling channel and the cooling air duct 710 are set in parallel. The cooling airflow may quickly pass through the cooling channel and carry away the heat of the cooling fins 731 and the heat-conducting substrate 732, thereby further improving the cooling efficiency.

As shown in FIG. 7, the cooling fins 731 include inner fins 7311 and outer fins 7312. The outer fins 7312 are arranged on both sides of the inner fins 7311, and the outer fins 7312 are thicker than the inner fins 7311. In this embodiment, the strength of the cooler 730 may be increased.

In this embodiment, the distance between two adjacent inner fins 7311 is 6 mm. Compared with the case of dense arrangements for cooling fins 731, the cooling airflow may quickly pass through the cooling channel, thus improving the cooling efficiency. The inner fins 7311 are thinner than the outer fins 7312. The thinner inner fins 7311 have higher cooling efficiency, while the thicker outer fins 7312 can improve the strength of the cooler 730.

In some embodiments, mounting channels are formed between the outer fins 7312 and the adjacent inner fins 7311, and screws pass through the heat-conducting substrate 732 through the mounting channels and are connected to the second partition plate 160.

In another embodiment, mounting channels are formed between the cooling fins 731, the mounting channels are perpendicular to the cooling channels, and screws pass through the heat-conducting substrate 732 through the mounting channels and are connected to the second partition plate 160.

Optionally, the air outlet surface of the fan 720 has a standard point in the vertical direction, and the distance between the standard point and the top of the air outlet surface is ⅓ times the height of the air outlet surface in the vertical direction. One end of the cooling fin 731 that is in contact with the heat-conducting substrate 732 is located on the horizontal plane of the standard point. To ensure a good cooling effect, the air outlet surface of the fan 720 passes through the cooling fins 731 as much as possible. In this embodiment, the top ends of the cooling fins 731, that is, the ends where the cooling fins 731 are connected to the heat-conducting substrate 732, are located at ⅓ of the vertical height of the air outlet surface. In this way, the cooling airflow may pass through most of the cooler 730, thereby improving the cooling effect.

As shown in FIG. 7, a second groove 163 is provided in a bottom wall of the first groove 162, the third through hole 161 is provided in a bottom wall of the second groove 163, a second boss part 7321 is formed on one face of the heat-conducting substrate 732 facing the second partition plate 160, and the second boss part 7321 is embedded in the second groove 163 to connect with the cooling end 320. In this embodiment, the second boss part 7321 is connected to the cooling end 320 to form a tight thermal conduction contact, which promotes the heat transfer process between the cooling end 320 and the heat-conducting substrate 732.

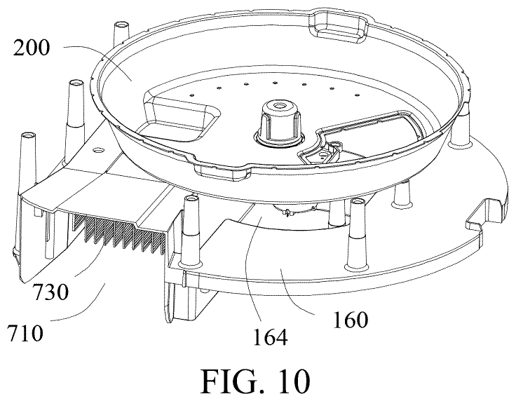

As shown in FIG. 10, a third groove 164 is formed in one side of the second partition plate 160 facing the first chamber. The feeder further includes a first drive mechanism 800 for driving the food bowl 400 to rotate. The first drive mechanism 800 is at least partially arranged in the third groove 164. This embodiment facilitates the miniaturization of the overall structure of the feeder.

In the specific implementation process, the third groove 164 is recessed from one side of the second partition plate 160 facing the first chamber to the fourth chamber. The food bowl 400 is located in the first chamber, and the first drive mechanism 800 is arranged between the food bowl 400 and the second partition plate 160. The first drive mechanism 800 drives the food bowl 400 to rotate in the first chamber. Further, the first drive mechanism 800 includes a first motor 810. An output shaft of the first motor 810 is in drive connection with the food bowl 400, and a plurality of food troughs 410 for placing food are formed on the food bowl 400. The positions of the food troughs 410 are switched by rotating the food bowl 400. The housing 100 is provided with a feeding port 610. The feeding port 610 communicates with the first chamber. The pet eats food in the food bowl 400 through the feeding port 610. By rotating the food bowl 400, the pet may select food from different food troughs 410 through the feeding port 610 provided in the housing 100.

To prevent pets from touching the internal structure of the housing 100, or from being injured by components such as the fan 720 and cooler 730 inside the housing 100, as shown in FIG. 7, the cooling assembly 700 includes an air inlet frame 121 and an air outlet frame 122. The air inlet frame 121 is mounted at the air inlet 7111, the air outlet frame 122 is mounted at the air outlet 7121. In addition, the arrangement of the air inlet frame 121 and the air outlet frame 122 can also prevent some debris from entering the cooling air duct 710 to cause damage.

In the specific implementation process, the air inlet 7111 and the air outlet 7121 are arranged on the two side walls of the housing 100, and the air inlet frame 121 and the air outlet frame 122 are connected to the housing 100, respectively.

### Door Plate Disassembly

In the technical solution of the present disclosure, as shown in FIGS. 11-20, the feeder includes a housing 100, an upper cover 600, a second drive mechanism 900, a door body 620, and a locking mechanism. The housing 100 defines an first chamber with a top opening. The upper cover 600 covers the housing 100 and is provided with a feeding port 610 communicating with the first chamber. The second drive mechanism 900 is mounted on the upper cover 600 and has a positioning part 910. The door body 620 is detachably connected to the positioning part 910. When the door body 620 is connected to the second drive mechanism 900, the second drive mechanism 900 drives the door body 620 to rotate, to open or close the feeding port 610. The second drive mechanism 900 is connected to the locking mechanism to drive the locking mechanism to rotate. The locking mechanism includes a locking member 920 and a reset member 930. The door body 620 has a clamping part 621 that is detachably connected to the locking member 920. The locking member 920 is movable between a locking position cooperating with the clamping part 621 and an unlocking position disengaging from the clamping part 621. The reset member 930 is connected to the locking member 920 and applies an elastic reset force to the locking member 920 such that the locking member 920 moves from the unlocking position to the locking position.

In this embodiment, when the door body 620 needs to be disassembled, the user first moves the locking member 920 to the unlocking position such that the door body 620 is unlocked from the locking mechanism, and then the door body 620 is disassembled from the positioning part 910 of the second drive mechanism 900. After disassembling the door body 620, the user may clean the door body 620. When the user needs to mount the door body 620 on the upper cover 600, the user first connects and positions the door body 620 and the second drive mechanism 900 through the positioning part 910, and then moves the locking member 920 to the locking position such that the locking mechanism locks the door body 620, thus achieving the quick mounting of the door body 620. When the second drive mechanism 900 is moving, the door body 620 and the locking mechanism that are connected to the second drive mechanism 900 rotate synchronously.

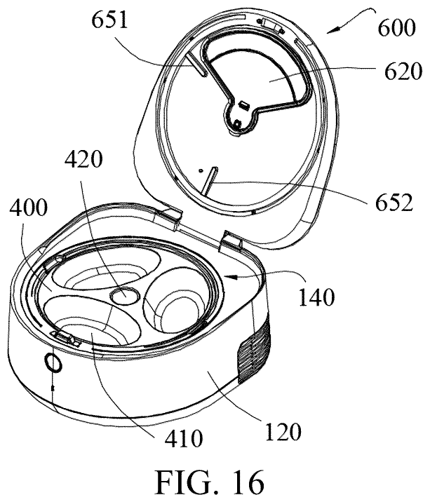

As shown in FIGS. 16-18, in this embodiment, the feeding port 610 passes through the upper cover 600, food is placed in the first chamber of the housing 100, the upper cover 600 covers the housing 100, and the pet eats the food in the first chamber through the feeding port 610. The outline and shape of the feeding port 610 are not limited in this embodiment. The size of the feeding port 610 can meet the needs of most pets or be set according to different pets. The door body 620 is rotatably connected to the upper cover 600, and the door body 620 is connected to the second drive mechanism 900. The second drive mechanism 900 drives the door body 620 to rotate, to open or close the feeding port 610. When the pet needs to be fed, the second drive mechanism 900 drives the door body 620 to rotate, to open the feeding port 610, and then the pet may eat the food in the first chamber through the feeding port 610. After the pet finishes eating, the second drive mechanism 900 drives the door body 620 to rotate reversely, to close the feeding port 610, so as to prevent the food from being exposed to the external environment for a long time and being contaminated and attracting flies and insects.

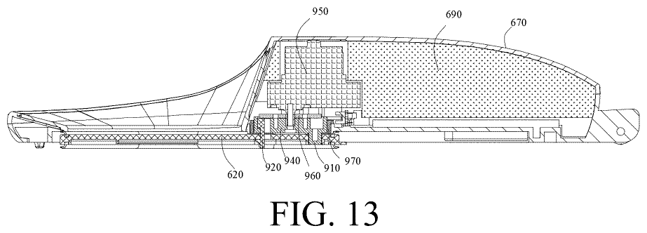

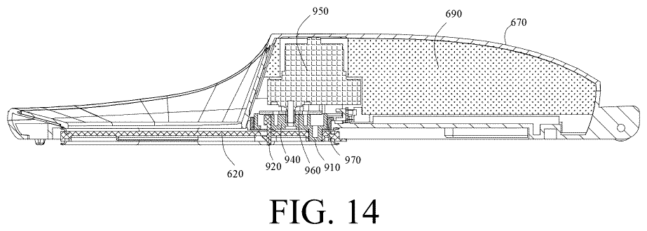

Referring to FIGS. 13-14, the second drive mechanism 900 also drives the locking mechanism to rotate, and the locking mechanism rotates synchronously with the door body 620. The locking mechanism includes a locking member 920 and a reset member 930. The door body 620 has a clamping part 621 that is detachably connected to the locking member 920, and the locking member 920 has a locking position and an unlocking position. Specifically, when the locking member 920 is in the locking position, the locking member 920 cooperates with the clamping part 621 such that the locking member 920 is connected to the door body 620, and under the drive of the second drive mechanism 900, the door body 620 rotates to open or close the feeding port 610. When the locking member 920 is in the unlocking position, the locking member 920 may disengage from the clamping part 621, and then the door body 620 disengages from the locking member 920. Furthermore, the door body 620 may also disengage from the positioning part 910 of the second drive mechanism 900. In this way, the door body 620 may be disassembled to be cleaned. When the door body 620 needs to be mounted, the door body 620 is first connected to the second drive mechanism 900 through the positioning part 910 to achieve positioning. Then the locking member 920 moves to the locking position such that the locking mechanism locks the door body 620, so as to mount the door body 620 quickly and conveniently. By reciprocating the locking member 920, the locking member 920 may reciprocate between the locking position and the unlocking position. The locking mechanism further includes a reset member 930. The reset member 930 is connected to the locking member 920 and applies an elastic reset force to the locking member 920 such that the locking member 920 moves from the unlocking position to the locking position. In addition, it should be appreciated that the door body 620 is provided with a component that cooperates with the positioning part 910. The cooperation of the component with the positioning part 910 achieves the positioning and connection of the door body 620, such that the second drive mechanism 900 drives the door body 620 to rotate.

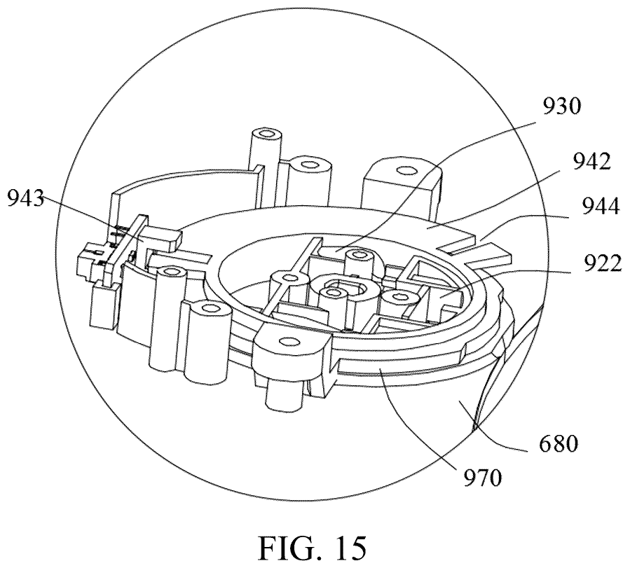

As shown in FIG. 15, the second transmission member 940 is formed with a protrusion on the surface near the door body 620. The protrusion is the positioning part 910. The door body 620 has a fifth through hole 623. The protrusion is embedded in the fifth through hole 623. The second transmission member 940 is also embedded into the fifth through hole 623 through the protrusion to achieve the rotation of the door body 620. When the user mounts the door plate onto the upper cover 600, the protrusion is first embedded into the fifth through hole 623 to achieve connection and positioning, and then the locking mechanism is mounted. The positioning part 910 facilitates the positioning and mounting of the door body 620, ensuring that the feeding port 610 can be accurately opened and closed during the rotation of the door body 620.

In the specific implementation process, the protrusion is adapted to the fifth through hole 623, and the protrusion may be integrally formed with the second transmission member 940 to improve the strength of the positioning part 910. The protrusion may also be recessed from one side of the second transmission member 940 deviating from the door body 620 to the door body 620, such that the protrusions are formed on opposite sides of the second transmission member 940. The cross-section of the protrusion and the fifth through hole 623 may be circular, square or other arbitrary shapes. In this embodiment, no limitations are made to the cross-section of the protrusion and the fifth through hole as long as the protrusion is compatible with the fifth through hole 623.

In another embodiment, the second transmission member 940 is provided with a fifth through hole, and the door body 620 is provided with a protrusion. The fifth through hole is a positioning part, and the protrusion is embedded in the fifth through hole, which may also drive the door body 620 to rotate. Details may be referred to the above embodiment and will not be described here.

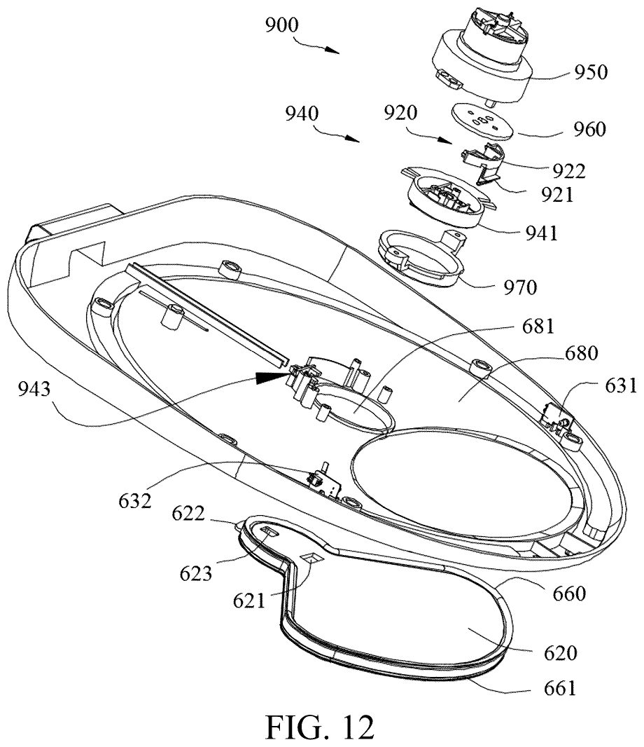

As shown in FIG. 12, the second drive mechanism 900 includes a second motor 950 and a second transmission member 940. One end of the second transmission member 940 is fixedly connected to a motor shaft of the second motor 950, and the other end of the second transmission member 940 is detachably connected to the door body 620. In the specific implementation process, the second motor 950 is mounted on the upper cover 600, the motor shaft of the second motor 950 is connected to the second transmission member 940, and the door body 620 is driven to rotate through the second transmission member 940. Specifically, the second transmission member 940 may be provided with a fixing hole, and the motor shaft of the second motor 950 is inserted into the fixing hole. It should be appreciated that a drive surface is formed between the motor shaft and the fixing hole. The motor shaft is in drive connection with the second transmission member 940 through the drive surface, and drives the second transmission component 940 to rotate, thereby driving the door body 620 to rotate. It should be appreciated that the fixing hole may be a blind hole or a through hole.

As shown in FIGS. 13-14, the locking member 920 has a hook part 921. The door body 620 has a sixth through hole, the sixth through hole is the clamping part 621. In the locking position, the hook part 921 passes through the sixth through hole and is hanged on one side of the door body 620 deviating from the upper cover 600. Specifically, the locking member 920 is connected to the second drive mechanism 900, and the hook part 921 of the locking member 920 is clamped with the door body 620, to achieve detachability of the locking member 920 and the door body 620. The hook part 921 is provided with a hook. When the locking member 920 is in the locking position, the hook 410 extends from the sixth through hole to one side of the door body 620 deviating from the upper cover 600 and is clamped with the door body 620. During disassembly, the hook part 921 is driven closely to the unlocking position such that the hook part 921 is away from the locking position, and then the hook part 921 is separated from the sixth through hole. In this way, the door body 620 is clamped with the locking member 920 and is detachably connected to the second transmission member 940, such that the door body 620 is clamped with the hook part 921 and the second motor 950 drives the door body 620 to rotate through the second transmission member 940, facilitating the disassembly.

As shown in FIG. 12, the second transmission member 940 includes a cylinder part 941. The cylinder part 941 includes a bottom wall and a side wall extending from an edge of the bottom wall to a direction away from the bottom wall, a mounting through hole is provided in the bottom wall, the locking member 920 has a fixing part 922, the fixing part 922 is connected to the hook part 921, the fixing part 922 is arranged in an accommodating space enclosed by the side wall and the bottom wall, and the hook part 921 extends out of the accommodating space from the mounting through hole.

As shown in FIG. 15, one end of the reset member 930 is connected to the fixing part 922, and the other end of the reset member 930 is connected to the cylinder part 941. In the specific implementation process, the reset member 930 is an elastic element, and the elastic force given to the fixing part 922 by the elasticity makes the hook part 921 firmly clamp with the door body 620. In this embodiment, the reset member 930 is a spring. One end of the spring abuts against the inner wall of the accommodating space, and the other end of the spring abuts against the fixing part 922, such that the fixing part 922 is tightly attached to the inner wall of the accommodating space, thereby causing the hook part 921 to abut against the side wall of the sixth through hole and ensuring the clamping effectiveness of the hook part 921 and the door body 620.

As shown in FIG. 12, the feeder further includes a pressing plate 960. The pressing plate 960 is arranged in the accommodating space. The pressing plate 960 is provided with a through hole suitable for the motor shaft of the second motor 950 to pass through, and the pressing plate 960 is arranged at the top end of the fixing part 922. The pressing plate 960 is fixedly connected to the second transmission member 940, for example, the pressing plate 960 is fixed to the second transmission member 940 by screws. The fixing part 922 and the reset member 930 are limited on one face of the pressing plate 960 facing the accommodating space.

As shown in FIG. 12, the upper cover 600 is fixedly mounted with a bushing 970, and the bushing 970 sleeves on an outer peripheral wall of the cylinder part 941. The outer wall of the cylinder part 941 of the second transmission member 940 is rotatably connected to the connecting hole 681 of the upper cover 600 through the bushing 970, to protect the upper cover 600 and prevent wear when the second transmission member 940 is rotating.

As shown in FIG. 15, the second transmission member 940 includes a sensing part 942 that extends from a circumferential edge of the cylinder part 941 to a direction away from the cylinder part 941. The feeder further includes a sensing switch 943 that is communicatively connected to the second motor 950, the sensing switch 943 is configured to detect the sensing part 942 to generate a control signal. The sensing part 942 includes two circumferentially spaced notches, the sensing switch 943 is a photoelectric switch, and a central angle formed between the two notches is the same as a rotation range angle of the door body 620.

In the specific implementation process, the sensing part 942 is arranged at one end of the cylinder part 941 deviating from the door body 620, extends from the circumferential edge of the cylinder part 941 to the direction away from the cylinder part 941, and is provided with two notches. The notches are spaced apart along the circumferential direction. In this embodiment, the sensing switch 943 is communicatively connected to the second motor 950. The sensing switch 943 is configured to detect the position of the door body 620, to achieve the rotation and positioning of the door body 620. It should be appreciated that the sensing switch 943 includes a transmitting end and a receiving end that are spaced apart from each other. The sensing part 942 rotates in the interval space between the transmitting end and the receiving end. When the notches rotate into the interval space, the light emitted by the transmitting end is received by the receiving end and a control signal is generated. The second motor 950 stops operating according to the control signal, such that the door body 620 is in an opening or closing state.

As shown in FIGS. 16-18, a first limiting part 651 and a second limiting part 652 that are spaced apart from each other are arranged on one side of the upper cover 600 facing the first chamber. When the door body 620 closes the feeding port 610 completely, the door body 620 abuts against the first limiting part 651. When the door body 620 opens the feeding port 610 completely, the door body 620 abuts against the second limiting part 652. The first limiting part 651 and the second limiting part 652 are integrally formed with the upper cover 600, which plays a role in limiting the rotation position of the door body 620, to prevent the door body 620 from rotating excessively.

Specifically, in one embodiment, a plurality of protrusions are formed on the face of the upper cover 600 facing the first chamber, and the protrusions are the first limiting part 651 and the second limiting part 652. The door body 620 rotates between the two protrusions and abuts against the side wall of the corresponding protrusion when rotating to the corresponding position.

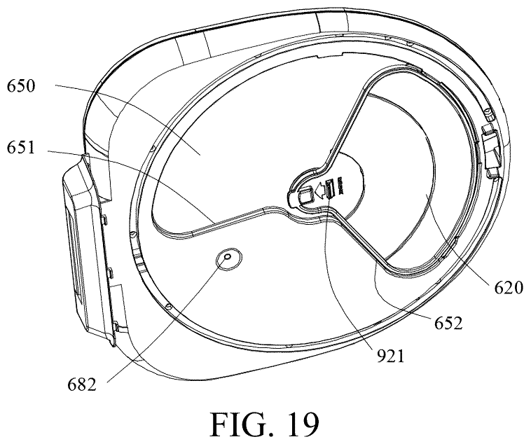

In another embodiment, as shown in FIG. 19, a fourth groove 650 is provided in one side of the upper cover 600 facing the first chamber, the door body 620 moves in the fourth groove 650, the fourth groove 650 is within the stroke range of the door body movement, and the groove walls that the fourth groove 650 abuts against the door body 620 are the first limiting part 651 and the second limiting part 652, respectively. In this embodiment, the door body 620 reciprocates within the fourth groove 650. The two groove walls of the fourth groove 650 form the first limiting part 651 and the second limiting part 652, which limit the rotation range of the door body 620.

As shown in FIG. 16, the feeder includes a first drive mechanism 800 and a food bowl 400 arranged in the first chamber. The food bowl 400 has a plurality of food troughs 410 for holding food. The first drive mechanism 800 is mounted on the housing 100 and drives the food bowl 400 to rotate such that at least one of the food troughs 410 is exposed to the feeding port 610.

In this embodiment, the first drive mechanism 800 drives the food bowl 400 to rotate circumferentially. In order to ensure that the food bowl 400 rotates smoothly and cooperates with the door body 620, the rotation shaft is the central shaft of the food bowl 400, and one side of the food bowl 400 is recessed to form the food trough 410. In this embodiment, the food bowl 400 forms a plurality of spaced food troughs 410. When the feeding port 610 is opened, the food trough 410 communicates with the outside world through the feeding port 610, and the pet eats the food in the food trough 410 through the feeding port 610. In this embodiment, the food bowl 400 may be rotated to switch different food troughs 410 to be opposite to the feeding port 610. If the user puts different foods in different food troughs 410, the pet may eat different foods in different food troughs 410 through the same feeding port 610, thus increasing the diversity of food for the pet. If different food troughs 410 are set to rotate to the feeding zone 115 at different time periods, automatic feeding at different time periods may be achieved.

As shown in FIGS. 16-18, the central position of the food bowl 400 is recessed in a direction away from the upper cover 600 to form an avoidance slot 420. When the upper cover 600 covers the housing 100, one end of the locking member 920 away from the upper cover 600 is located in the avoidance slot 420. Since the locking element 920 rotates synchronously with the door body 620 under the drive of the second motor 950, and the food bowl 400 rotates circumferentially under the drive of the first drive mechanism 800. When the upper cover 600 covers the housing 100, one end of the locking element 920 deviating from the upper cover 600 is just located in the avoidance groove 420, which does not affect the rotation of the door body.

As shown in FIG. 12, in order to seal the door body 620 and the upper cover 600 and prevent flies or insects from entering the food bowl 400 through a gap formed between the door body 620 and the upper cover 600, the door body 620 is provided with a first sealing member 660 that is in contact with the upper cover 600.

In this embodiment, the first sealing member 660 is arranged on one side of the door body 620 deviating from the second sealing member 661 and is in contact with the upper cover 600, thereby improving the sealing performance between the door body 620 and the upper cover 600. Specifically, the first sealing member 660 is made of flexible rubber and the like to ensure good sealing performance.

As shown in FIG. 12, in order to seal the door body 620 and the food bowl 400 and prevent flies or insects from getting contact with the food through the gap formed between the door body 620 and the food bowl 400, in this embodiment, the door body 620 is connected to a second sealing member 661. The second sealing member 661 is also in contact with the food bowl 400, thereby achieving the seal between the door body 620 and the food bowl 400. It should be appreciated that the second sealing member 661 is made of flexible rubber and the like to ensure good sealing performance. Specifically, the second sealing member 661 is a sealing ring, which is arranged around the door body 620 and fixed to the edge of the door body 620.

In another embodiment, the upper cover 600 is provided with a third sealing member that is in contact with the door body 620. The third sealing member is arranged on one side of the upper cover 600 facing the door body 620. The third sealing member may be in contact with the upper cover or the first sealing member 660, to improve the sealing performance between the door body and the upper cover.

As shown in FIG. 12, the door body 620 is also equipped with a door handle 622. In this embodiment, the door handle 622 is arranged at the opposite end of the part of the door body 620 used to cover the feeding port 610. Holding the door handle 622 makes it convenient to disassemble and mount the door body 620.

As shown in FIG. 11, the upper cover 600 includes an upper housing 670 and a lower housing 680 that are detachably connected to each other, and a cavity is formed between the upper housing 670 and the lower housing 680. The door body 620 is arranged on one side of the lower housing 680 deviating from the upper housing 670. The feeding port 610 passes through the upper housing 670 and the lower housing 680. A heat insulation layer 690 is arranged in the cavity.

As shown in FIG. 19, a fifth groove 682 used for mounting a temperature sensor is arranged on one side of the upper cover 600 facing the first chamber. The technical solution in this embodiment can sense and measure the temperature of the first chamber.

In the specific implementation process, the temperature sensor is arranged on the upper cover 600 and avoids the rotation range of the door body 620. The temperature sensor includes a body and a temperature measuring end. The temperature measuring end is arranged towards the first chamber, and the body is arranged inside the upper cover 600. The temperature measuring end is configured to sense and measure the temperature of the first chamber.

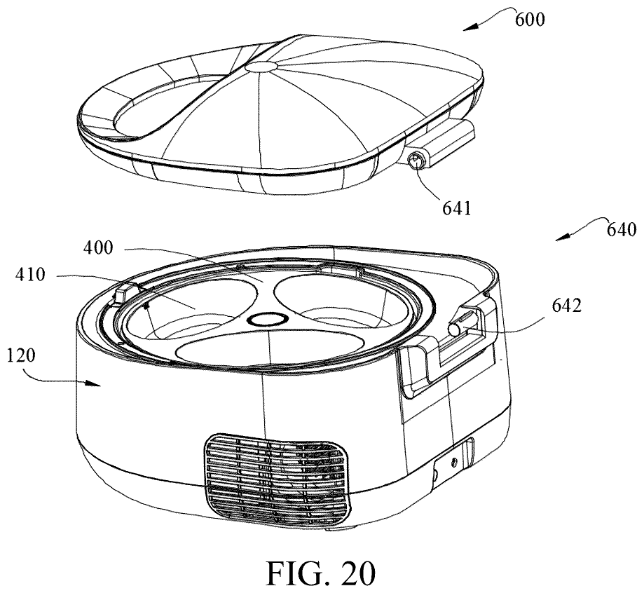

As shown in FIG. 20, the upper cover 600 is hinged to the housing 100 through a hinge shaft. The hinge shaft is equipped with a damper 640. The damper 640 includes a damping sleeve 641 with a cavity and a rotating member 642 arranged in the cavity. The rotating member 642 is driven to rotate by the hinge shaft. A damping medium is arranged between the damping sleeve 641 and the rotating member 642. When the user opens the upper cover 600, the damper 640 enables the upper cover 600 to have a damping effect when the upper cover 600 is rotationally opened.

As shown in FIG. 11, the upper cover 600 includes a light-transparent part 630 that is arranged near the feeding port 610. The upper cover 600 is equipped with a light emitting device 631 and a light receiving device 632 that correspond to the light-transparent part 630, the light emitting device 631 is configured to allow emitted light to pass through the light-transparent part 630, and the light receiving device 632 is configured to receive the light emitted from the light-transparent part 630. The solution in this embodiment may allow detect whether a pet is near the feeding port 610.

In the specific implementation process, the light emitting device 631 and the light receiving device 632 are communicatively connected to the second drive mechanism 900. The light emitting device 631 emits infrared light, and the light receiving device 632 is configured to receive infrared light. When the infrared light is disconnected, causing the light receiving device 632 to not receive infrared light, a control signal will be generated and sent to the second drive mechanism 900, such that the second drive mechanism 900 controls the opening of the door body 620. In practice, when a pet approaches the feeding port 610 and needs to eat, the pet is detected by infrared light, and the second drive mechanism drives the door body 620 to open the feeding port 610 to allow the pet to eat. During the pet's feeding process, the infrared light will continuously detect the existence of the pet, and if the pet does no leave, the second drive mechanism will not drive the door body 620 to close the feeding port 610.

In this embodiment, the upper cover 600 is connected to an infrared lens and is arranged at the feeding port 610. The infrared lens is a light-transparent part 630. The light emitted by the light emitting device 631 passes through the light-transparent part 630 and is received by the light receiving device 632.

The above are only the preferred embodiments of the present disclosure, instead of limiting the scope of the present disclosure. Without departing from the concept of the present disclosure, the equal structural transformations made according to the contents of the specification and the accompanying drawings or direct/indirect application in other related technical fields shall fall within the scope of the present disclosure.

1. A feeder, comprising:
a housing comprising a first partition plate, wherein the first partition plate divides an interior of the housing into a first chamber and a second chamber which are spaced apart in a vertical direction, and the first partition plate is formed with a first through hole;
a metal inner container arranged in the first chamber;
a semiconductor refrigeration sheet having a refrigeration end and a cooling end that are arranged relative to each other, wherein the metal inner container is connected to the refrigeration end;
a food bowl arranged in the first chamber, wherein the food bowl is refrigerated by the refrigeration end through a heat exchange process between the metal inner container and the refrigeration end; and
a first heat insulation member at least arranged between the first partition plate and a plane at which the semiconductor refrigeration sheet is located.

2. The feeder according to claim 1, wherein the metal inner container comprises a body part and a first boss part which are connected to each other, wherein the body part is arranged in the first chamber;
wherein the first boss part passes through the first through hole and is connected to the refrigeration end;
wherein the first heat insulation member is arranged around the first boss part.

3. The feeder according to claim 2, wherein the feeder comprises a surrounding plate, the surrounding plate extends downward from an inner peripheral wall of the first through hole, an outer peripheral wall of the surrounding plate is connected to the first heat insulation member, and an inner peripheral wall of the surrounding plate is connected to the first boss part.

4. The feeder according to claim 3, wherein a bottom wall of the first boss part is connected to the refrigeration end, and a side wall of the first boss part is connected to the surrounding plate.

5. The feeder according to claim 1, wherein the semiconductor refrigeration sheet is located below the first through hole;
wherein a part of the first partition plate is located at a lower part of the first partition plate;
wherein the semiconductor refrigeration sheet is surrounded by the first heat insulation member along a circumferential direction of the semiconductor refrigeration sheet when observed from a perspective of viewing from top to bottom.

6. The feeder according to claim 5, wherein a gap is formed between the semiconductor refrigeration sheet and the lower part of the first partition plate in the vertical direction;
wherein the semiconductor refrigeration sheet is surrounded by a part of the first heat insulation member along the circumferential direction of the semiconductor refrigeration sheet which part is located at the lower part of the first partition plate when observed from the perspective of viewing from top to bottom.

7. The feeder according to claim 6, wherein a heat conducting member is arranged between the metal inner container and the semiconductor refrigeration sheet in the vertical direction;
wherein the heat conducting member respectively contacts the metal inner container and the refrigeration end.

8. The feeder according to claim 7, wherein the heat conducting member passes through the first through hole and is respectively connected to the metal inner container and the refrigeration end.

9. The feeder according to claim 7, wherein the part of the first heat insulation member located at the lower part of the first partition plate is located between the lower part of the first partition plate and the refrigeration end in the vertical direction, and surrounds the heat conducting member from a circumferential direction of the heat conducting member.

10. The feeder according to claim 1, wherein the first partition plate comprises a refrigeration zone and a feeding zone, the refrigeration zone and the feeding zone are arranged along a circumferential direction of the first chamber, an area of the refrigeration zone is larger than an area of the feeding zone, and the metal inner container is arranged in the refrigeration zone.

11. The feeder according to claim 1, wherein the housing further comprises an inner cylinder; the first partition plate is connected to an inner peripheral wall of the inner cylinder, such that the first partition plate and the inner cylinder surround to form the first chamber.

12. The feeder according to claim 11, wherein the housing further comprise an outer cylinder and a bottom plate, the outer cylinder is located outside the inner cylinder, the bottom plate is connected to a bottom end of the outer cylinder, such that the outer cylinder, the first partition plate, and the bottom plate surround to form the second chamber; and
wherein the first heat insulation member is arranged inside the second chamber.

13. The feeder according to claim 12, wherein the feeder further comprises a second partition plate, the second partition plate is arranged between the first partition plate and the bottom plate, the second partition plate is connected to an inner peripheral wall of the outer cylinder, the second partition plate is provided with a third through hole, the third through hole is provided correspondingly to the cooling end, and the first heat insulation member is mounted on the second partition plate.

14. The feeder according to claim 13, wherein the feeder further comprises a cooling assembly; a first groove is formed in one side of the second partition plate facing the bottom plate, the first groove and the bottom plate form a cooling air duct together, and the cooling assembly is arranged in the cooling air duct and is configured to cool the cooling end.

15. The feeder according to claim 14, wherein the cooling assembly comprises a fan, the cooling air duct comprises an air inlet duct and an air outlet duct, wherein an air inlet of the cooling air duct and an inlet side of the fan are in communication with the air inlet duct, an air outlet of the air outlet duct and an air outlet side of the fan are in communication with the air outlet duct, and an overflowing area of at least a section of the air outlet duct or the air inlet duct gradually increases along a direction of the air outlet.

16. The feeder according to claim 14, wherein the cooling assembly comprises a cooler, the cooler comprises a heat-conducting substrate and a plurality of cooling fins, the heat-conducting substrate is connected to the cooling end, the plurality of cooling fins are distributed on the heat-conducting substrate at intervals, a cooling channel is formed between two adjacent cooling fins, and an extending direction of the cooling channel is identical to an extending direction of the cooling air duct.

17. The feeder according to claim 16, wherein a second groove is provided in a bottom wall of the first groove, the third through hole is provided in a bottom wall of the second groove, a second boss part is formed on one face of the heat-conducting substrate facing the second partition plate, the second boss part is embedded in the second groove to connect with the cooling end;
and/or, wherein the cooling fins comprises inner fins and outer fins, the outer fins are arranged on both sides of the inner fins, and the outer fins are thicker than the inner fins;
and/or, wherein a third groove is formed in one side of the second partition plate facing the first chamber, the first drive mechanism is at least partially arranged in the third groove.

18. The feeder according to claim 15, wherein the cooling assembly includes an air inlet frame and an air outlet frame, the air inlet frame is mounted at the air inlet, the air outlet frame is mounted at the air outlet, the air inlet frame and/or the air outlet frame are both detachably connected to the housing.

19. The feeder according to claim 10, wherein the feeder further comprises a first drive mechanism for driving the food bowl to rotate;
wherein the first heat insulation member has a second avoidance cavity for avoiding the first drive mechanism;
wherein the first drive mechanism comprises a first motor and a first transmission member which are connected to each other, the first motor is arranged in the second avoidance cavity, the first transmission member passes through the first partition plate and enters the first chamber;
wherein the food bowl is detachably mounted to the first transmission member.

20. The feeder according to claim 19, wherein a plurality of food troughs are formed on the food bowl, the plurality of food troughs are distributed at intervals along a circumferential direction of the food bowl;
wherein the first drive mechanism rotates the food bowl to switch the food troughs from the refrigeration zone to the feeding zone.

21. The feeder according to claim 20, wherein the food bowl comprises:
a bracket detachably mounted to the first transmission member, and the bracket is made of a heat insulating material;
a plurality of food containers, each of the food containers is detachably mounted to the bracket, and the food troughs are respectively formed in the food containers.

22. The feeder according to claim 10, wherein the metal inner container is in an arc-shape plate, and the metal inner container is laid in the refrigeration zone of the first partition plate;
wherein the feeder further comprises a heating member arranged in the feeding zone of the first partition plate;
wherein the metal inner container and the heating element are separated from each other.

23. The feeder according to claim 22, wherein the first heat insulation member comprises a part located below the feeding zone of the first partition plate.

24. The feeder according to claim 1, wherein the housing comprises an upper cover that covers the first chamber, and the upper cover is provided with a feeding port communicating with the first chamber;
wherein the feeder further comprising:
a second drive mechanism mounted on the upper cover, wherein the second drive mechanism a positioning part;
a door body detachably connected to the positioning part, wherein when the door body is connected to the second drive mechanism, the second drive mechanism drives the door body to rotate, to open or close the feeding port; and
a locking mechanism, wherein the second drive mechanism is connected to the locking mechanism to drive the locking mechanism to rotate, the locking mechanism comprises a locking member and a reset member, the door body has a clamping part that is detachably connected to the locking member, the locking member is movable between a locking position cooperating with the clamping part and an unlocking position disengaging from the clamping part, and the reset member is connected to the locking member and applies an elastic reset force to the locking member such that the locking member moves from the unlocking position to the locking position.
